(19) United States
(12) Patent Application Publication
(10) Pub. No.: US 2004/0125477 A1
(43) Pub. Date: Jul. 1, 2004

(54) Rear view hunting mirror

(76) Inventors: Dax Glenn Carter, Rossville, TN (US); Norval Shea Smith, Collierville, TN (US)

Correspondence Address: Dax G. Carter, 100 Cotton Bend Dr., Rossville, TN, 38066, US

(21) Appl. No.: 10/730,384

(22) Filed: Dec. 8, 2003

Related U.S. Application Data
(60) Provisional application No. 60/436,729, filed on Dec. 30, 2002.

(51) Int. Cl. G02B 7/182

(52) U.S. Cl. 359/881; 359/871

(57) ABSTRACT

A rear view hunting mirror which is characterized by a mirror mounted on one end of a flexible “gooseneck” coupling, with a curved mount bracket attached to the opposite end of the flexible coupling and fitted with an adjustable mount strap and buckle combination for attaching the rear view hunting mirror to a post, tree or a tree limb. The mirror can then be manipulated into position in front of a hunter in the tree or a hunter positioned on a tree stand attached to the tree or post, for viewing the area behind the hunter and spotting game in that area. A camouflage sheath can be fitted over the flexible coupling to aid in camouflaging the rear view hunting mirror from deer and other game. The flexible coupling has multiple, removable coupling digits connected in a friction-fit and attached to the mirror and to the bracket to facilitate a flexible coupling of desired length.

### CROSS-REFERENCE TO RELATED APPLICATIONS

This application claims the benefit of co-pending U.S. Provisional Application Ser. No. 60/436,729, filed Dec. 30, 2002.

### BACKGROUND OF THE INVENTION

1. Field of the Invention

This invention relates to hunting from elevated structures such as trees, poles and the like having curved surfaces and more particularly, to a rear view hunting mirror designed for attachment to a tree, pole or other rounded supporting structure and adjustment forwardly of the hunter for viewing the area behind the hunter. In a preferred embodiment a curved surface of a tree, limb, pole or similarly shaped support object and is typically secured in place by means of a strap and buckle combination. A flexible “gooseneck” coupling extends from the mount bracket and a mirror is mounted on the opposite end of the flexible coupling, which mirror can be adjusted forwardly of the hunter in the tree or on the pole or tree in a climbing stand, for example, to view a target area rearwardly of his or her position in the tree or on the stand attached to the tree or pole. In a preferred embodiment the flexible coupling is of a conventional design having articulating, removable coupling digits snapped together in a friction-fit and fixed to the mirror on one end and attached to the mount bracket on the opposite end to facilitate adding and removing coupling digits and fabricating a flexible connection of selected length for the purpose.

One of the problems realized in hunting is the difficultly of viewing the area behind the hunter when the hunter is located in a tree or on a climbing stand or other device attached to a tree or pole for hunting purposes. Viewing the area behind the hunter is difficult, not only because of the tree or pole which the hunter is supported on or positioned in, but also because of the awkward, uncomfortable body movements necessary in order to turn the head to the desired extent for such viewing. Accordingly, the rear view hunting mirror of this invention facilitates a clear rear view and solves the problem of the tree or support itself as a blocking obstacle, as well as the necessity of moving the body and turning the neck and head in uncomfortable positions for viewing purposes.

2. Description of Prior Art

Various types of rear view hunting mirror apparatus exist in the prior art to aid hunters. For example, U.S. Pat. No. 6,220,717 to Pastore (dated Apr. 24, 2001) depicts a hunting mirror that uses a clamp to secure it to the hunter's tree stand. Although the Pastore device is meant to be clamped to any area of a tree stand, it only works efficiently by clamping the mirror to the rails of a tree stand where the mirror is in the hunter's line of vision. Furthermore, not all tree stands have rails where the hunter can clamp the mirror within their line of vision.

Another type of hunting mirror device is U.S. Pat. No. 5,383,061 to Lanier (dated Jan. 17, 1995). The Lanier device includes a spike for penetrating the tree trunk to secure the hunting mirror in place, and this particular device is used specifically with tree stands in which the hunter faces the tree. The Lanier device, therefore, has a couple of problems. First of all, only hunters who use a tree stand that faces the tree can use this device. Secondly, since the spike penetrates the tree trunk, the Lanier device damages the tree.

Yet another type of hunting mirror device is found in Varmint Masters magazine, Thicket Publishing inc., issue no. 2, of 1996 on page 56 (Pat. Pending to Todd Fontenot). The Fontenot device is limited in several ways. First, the device uses a flexible rod, to which the mirror attaches, that is not adjustable for length. This is a limitation for hunters who use tree stands which face the tree because the flexible rod is too long to position the mirror close to the tree, which is the optimal place for use with this type of tree stand. If the mirror were close to the tree it would keep the device out of the way of the hunter and still within the hunter's line of vision. Second, the entire length of the flexible rod is one piece. This is not nearly as adjustable as a flexible “gooseneck” made up of a multiple coupling digits, which permit movement at every digit, thus permitting more adjustability. Third, the Fontenot device attaches to a tree using either screws or a plastic cable tie. Using the screws to mount the device is time consuming, damaging to the tree and requires the hunter to carry the tooling necessary to attach or detach the device. Using the cable tie to attach the device to a tree is a one-time use attachment method. After the cable tie is cinched down it must be cut off to be removed and thus requires another new cable tie to remount the device and a cutting tool to remove it. Forth, when the Fontenot device is mounted to a tree, the mounting base, which makes contact with the tree, is flat. A flat surface mounted to a round surface (a tree) only has one point of contact, making the flat surface prone to teeter on the round surface. Therefore, the flat base does not provide near the stability as would a mounting base that had more than one point of contact on the trees surface.

Objects and Advantages

Accordingly, several objects and advantages of my invention are:

a) An object of this invention is to provide a new and improved rear view hunting mirror for use with all tree stands in order to overcome the deficiencies previously noted in prior art. My device can be used with any type of tree stand, whether the tree stand used faces the hunter toward the tree or away from the tree and whether the tree stand has rails or not, because my device attaches around the tree and not to the stand.

b) Another object of this invention is to provide a new and improved rear view hunting mirror in which the length of the flexible “gooseneck” can be adjusted repeatedly to fit the hunter's preference and needs. If the hunter is in a tree stand, which faces away from the tree in which they are seated, they may want to use the full length of the flexible “gooseneck”. If the hunter is in a tree stand, which faces the tree in which they are seated, they may want to shorten the flexible “gooseneck” by removing as many coupling digits desired in order to position the mirror closer to the tree trunk that they are facing. This keeps the rear view hunting mirror out of the hunter's way and from obstructing the hunter's view.

c) Yet another object of this invention is to provide a new and improved rear view hunting mirror that uses a flexible “gooseneck” comprised of multiple coupling digits which enables more adjustability and articulation than a one piece flexible rod, as noted in prior art.

d) Still another object of this invention is to provide a new and improved rear view hunting mirror which can be attached to a tree without damaging the tree. This is because my design does not penetrate the tree's surface.

e) Yet another object of this invention is to provide a new and improved rear view hunting mirror in which all parts are reusable as opposed to one-time use parts such as cable ties noted in prior art.

f) Still another object of this invention is to provide a new and improved rear view hunting mirror which can be firmly secured to a tree, limb or pole by means of a mounting bracket having two parallel bracket edges. Two parallel bracket edges provide more distribution of surface contact with the tree, limb or pole preventing teetering associated with a flat mounting base, as noted in the prior art. Therefore, the more distribution of surface contact there is the more firmly seated the mount bracket is to the tree, limb or pole surface.

g) Another object of this invention is to provide a new and improved rear view hunting mirror that can be attached and removed from a tree, limb or pole without the use of tooling. This is because my design uses a strap, hook and buckle combination, which makes for easy and quick attachment or removal from a tree, limb or pole by hand.

### BRIEF DESCRIPTION OF THE DRAWINGS

The invention will be better understood by reference to the accompanying drawings wherein:

FIG. 1 is a perspective view of a preferred embodiment of the rear view hunting mirror of this invention mounted in functional configuration for viewing by a hunter (not illustrated) who may be seated on a climbing hunting stand beneath the rear view hunting mirror;

FIG. 2 is a front perspective view of the rear view hunting mirror illustrated in FIG. 1, with the mount strap removed for brevity;

FIG. 3 is a rear perspective view of the rear view hunting mirror illustrated in FIG. 2, more particularly illustrating a preferred technique for removably mounting the flexible coupling to the mount bracket;

FIG. 4 is a perspective view of the rear view hunting mirror illustrated in FIGS. 1-3, more particularly illustrating the use of multiple removable coupling digits snapped together in a friction-fit to define the flexible coupling which mounts the mirror to the mount bracket and facilitates articulation of the coupling digits and orientation of the mirror in any desired configuration with respect to a tree limb using a mount strap and buckle combination;

FIG. 5 is a perspective view of the rear view hunting mirror, typically attached to a tree limb using the mount strap and more particularly illustrating a desired positioning of the mirror by manipulation of the flexible coupling; and

FIG. 6 is a perspective view of a mount bracket and an alternative friction buckle design for tightening the mount bracket on a fixed object.

### DESCRIPTION OF THE PREFERRED EMBODIMENTS

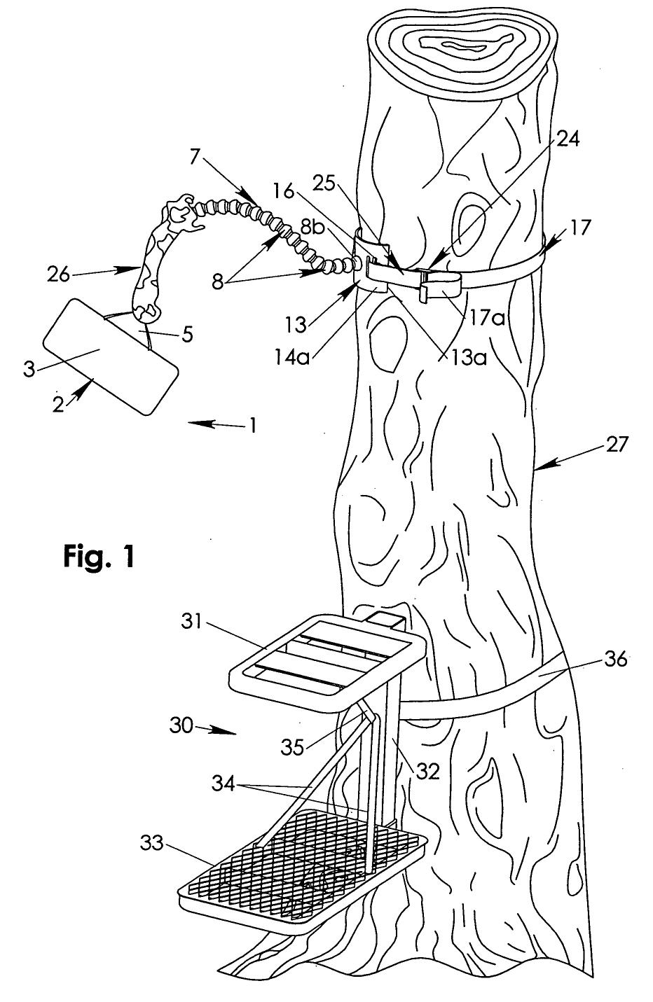

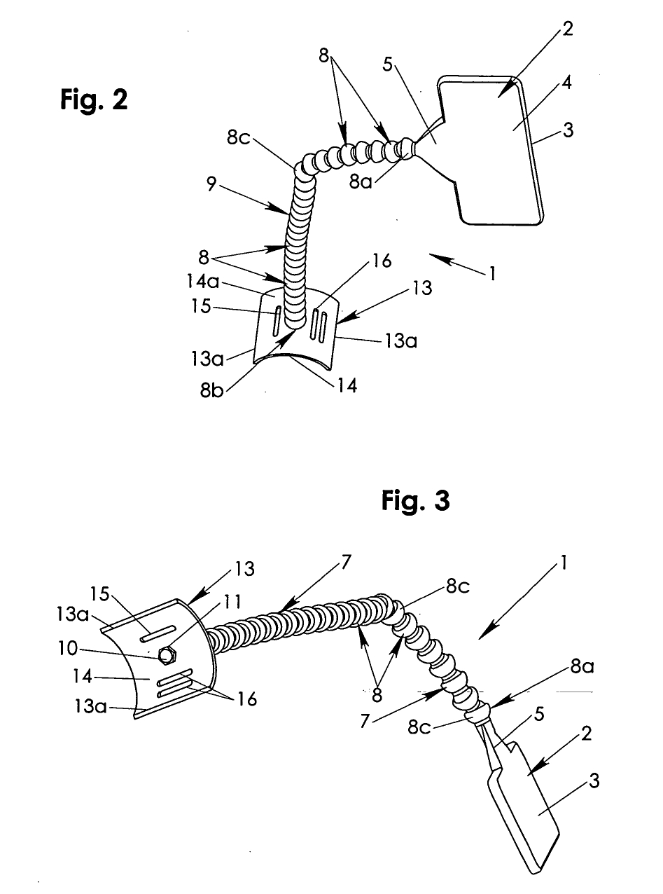

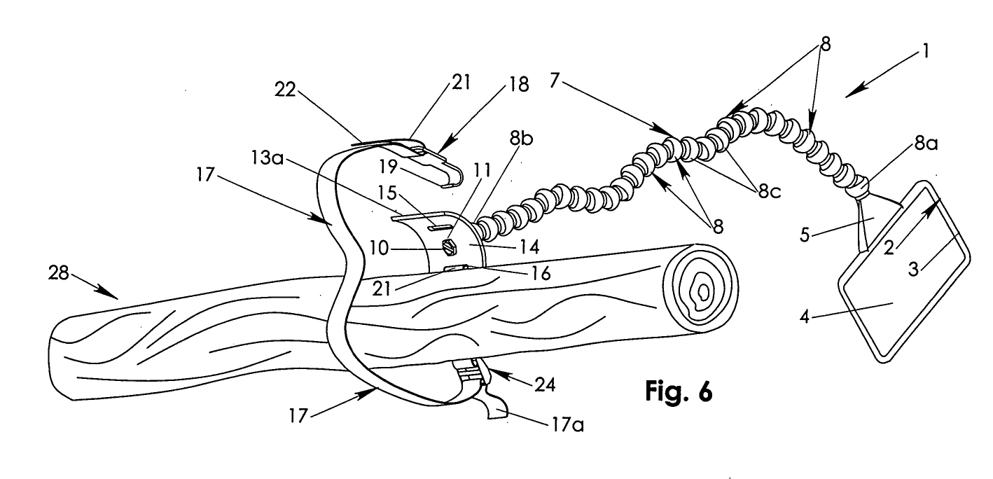

Referring initially to FIGS. 1-3 of the drawings in a preferred embodiment, the rear view hunting mirror of this invention is generally illustrated by reference numeral 1. The rear view hunting mirror 1 includes a mirror 2, consisting of a typically plastic mirror plate 3 that has a reflecting surface 4 and is fitted with a coupling bracket 5 for fixing the mirror plate 3 to one end of a flexible coupling 7 using a fixed digit 8a, located at one end of multiple coupling digits 8, as illustrated in FIGS. 2 and 3. As illustrated in FIG. 6 each of the coupling digits 8, as well as the fixed digit 8a, has a digit ball 8d, shaped to snap into an adjacent digit cup 8c in a friction-fit to facilitate articulation between the respective digit balls 8d and corresponding digit cups 8c. As further illustrated in FIGS. 1-3 the opposite end of the flexible coupling 7 is terminated by a mount bracket digit 8b, having a digit ball 8d secured to a curved or arcuate mount bracket 13 by means of a nut 11, threaded on a bolt 10 that extends through a washer 9 and through aligned openings (not illustrated) in the digit ball 8d and the mount bracket 13, respectively. As further illustrated in FIGS. 2 and 3 of the drawings the arcuate mount bracket 13 is characterized by a concave surface 14 and a convex surface 14a, terminated by parallel bracket edges 13a, and is fitted with a blade slot 15 and parallel strap slots 16 on opposite sides of the nut 11, as illustrated.

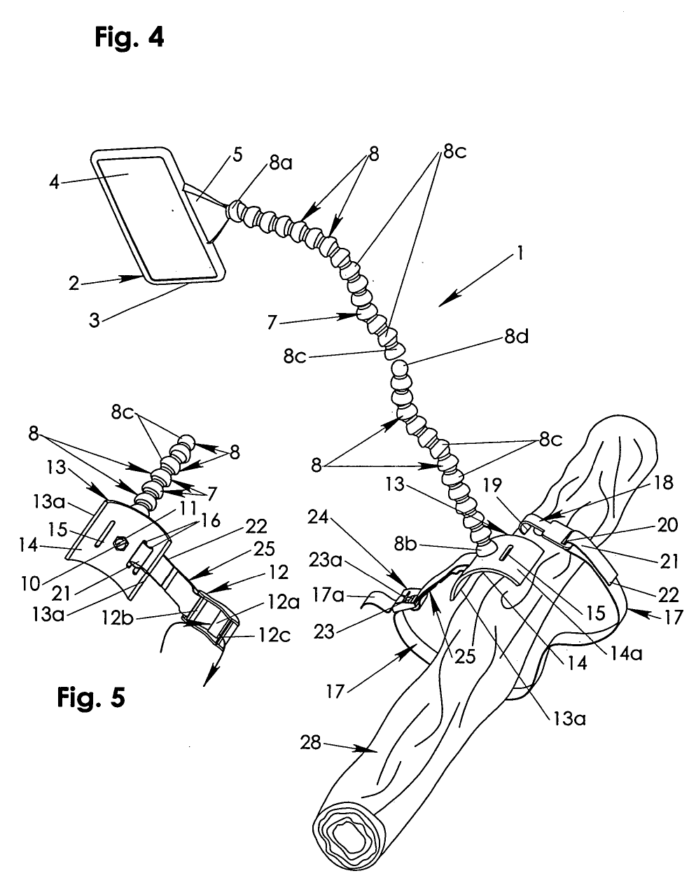

Referring now to FIGS. 1 and 4-6 of the drawings the mount strap 17 receives a strap hook 18 on one end, which strap hook 18 is typically curved to define an engaging blade 19 for removably engaging the blade slot 15 in the mount bracket 13 when the rear view mirror 1 is in functional, mounted position on a tree 27, as illustrated in FIG. 1. In a preferred embodiment, engagement between the mount strap 17 and the strap hook 18 is effected by means of a strap loop 21, shaped in one end of the mount strap 17 and extending through a strap hook loop slot 20 (FIG. 4) provided in the strap hook 18, to define a strap loop end 22 that is sewn or otherwise attached to the mount strap 17 to secure the strap hook 18 on one end of the mount strap 17. The opposite end of the mount strap 17 is typically removably engaged with a cam buckle 24, typically by extending the mount strap 17a through an opening or slot (not illustrated) in the cam buckle 24. The cam buckle 24 is secured to the mount bracket 13 by a buckle strap 25, also having a strap loop 21 and strap loop end 22 extending through the parallel strap slots 16. This attachment prevents engagement between the buckle strap 25 and the adjacent bracket edge 13a and effects tightening of the mount strap 17 on the tree 27 (FIG. 1) or the tree limb 28 (FIGS. 4 and 5), firmly seating the bracket edges 13a of the mount bracket 13 on the bark of the tree 27 or tree limb 28 and securing the rear view hunting mirror 1 in place. In a preferred embodiment the cam buckle 24 is of the cam-operated type known to those skilled in the art which facilitates manipulation of a lever 23 (FIG. 4) to tighten the cam element 23a (FIG. 4) against the mount strap end 17a, as illustrated in FIG. 1. In another preferred embodiment the diameter of a circle defining the arc or curvature of the mount bracket 13 is less than the diameter and curvature of the chosen tree 27 or tree limb 28, to insure tight seating of the parallel bracket edges 13a on the tree or limb surfaces and optimum securing of the mount bracket 13 in place.

Alternatively, the cam buckle 24 may be replaced with a friction buckle 12, as illustrated in FIG. 5, where the buckle strap 25 is attached to the friction buckle 12 and mount strap 17 (not illustrated) is inserted in the opening between the tension pin 12b and the strap pin 12a and then through the space between the strap pin 12a and the teeth 12c, in the direction of the arrows. In each event, the cam buckle 24 or friction buckle 12 facilitates tightening of the mount strap 17 around the tree 27 or the tree limb 28 to tightly seat the parallel bracket edges 13a terminating the concave surface 14 of the mount bracket 13, on the larger curvature of the tree 27 or the tree limb 28. This preferred seating configuration of the bracket edges 13a of the mount bracket 13 has been found to be extremely important to facilitate non-slip, yet quick, easy and removable attachment of the rear view hunting mirror 1 to the tree 27 or the tree limb 28 with minimum movement of the mirror 2 and corresponding minimum distortion of the rear view field in the reflecting surface 4 of the mirror 2 during hunting. As further illustrated in FIG. 1 of the drawings a camouflage sleeve 26 is optionally provided on the flexible coupling 7 for camouflaging the flexible coupling 7.

Referring again to FIG. 1 of the drawings a hunter (not illustrated) may be seated on the seat 31 of a climbing deer stand 30, which is attached to a tree 27 by means of a support strap 36 and is typically operated to climb the tree in “inchworm” fashion, according to the knowledge of those skilled in the art. The climbing deer stand 30 is typically further provided with a seat support 32, to which the seat 31 is mounted and to which a foot support 33 is positioned beneath the seat 31 and both are secured in place on the seat support 32 by means of foot braces 34 and a seat brace 35. The hunter can therefore sit on the seat 31, attach the rear view hunting mirror 1 to the tree 27 above the climbing tree stand 30 and position the mirror 2 in a desired location forwardly of the hunter for viewing the area behind the hunter.

Accordingly, in operation, it will be appreciated by those skilled in the art that the hunter may initially ascend to the tree 27 in conventional manner using the climbing tree stand 30, with the rear view hunting mirror 1 carried in a backpack or otherwise. When the hunter reaches the desired height on the tree 27, he then secures the climbing tree stand 30 in place, typically using the support strap 36 and seats himself on the seat 31, typically, but not necessarily, with his back to the tree 27 and his feet resting on the foot support 33. He is now in position to mount the rear view hunting mirror 1 on the tree 27 above his head by simply encircling the tree 27 with the mount strap 17, equipped with the cam buckle 24 or the friction buckle 12 to cause the bracket edges 13a of the curved mount bracket 13 to tightly engage the surface of the tree 27. Since the mount bracket 27 is curved and includes a concave surface 14 bounded by the bracket edges 13a, (FIG. 3), it may be tightly and securely coupled to the tree 27 of larger diameter and curvature, to facilitate minimum movement or vibration of the flexible coupling 7 extending from the mount bracket 13 and corresponding minimal movement of the mirror 2 on the opposite end of the flexible coupling 7. If desired, a camouflage sleeve 26 may be extended over the flexible coupling 7 to help camouflage the rear view hunting mirror 1. The mirror 2, along with the mirror plate 3, is then adjusted approximately into the position illustrated in FIG. 1 to facilitate a rear view of the hunter. Rotatable and spatial adjustment of the mirror 2 can be made at any time using the flexible coupling 7 as the coupling digits 8 rotate and articulate with respect to each other in the adjusting process, to better position the mirror2, such that the reflecting surface 4 allows the hunter to command viewing of an area of the forest or hunting terrain behind the hunter as he is seated on the climbing tree stand 30 or on a ladder stand or other support (not illustrated), as the case may be.

Referring now to FIG. 4 of the drawings, alternatively, under circumstances where it is not convenient or expedient to mount the rear view hunting mirror 1 on the tree 27 as illustrated in FIG. 1, the rear view hunting mirror 1 can be mounted on a tree limb 28, preferably, but not necessarily, having a curvature larger than the curvature of the mount bracket 13, in the position illustrated in FIG. 4 and adjusted as described above to command a view of the terrain behind the hunter. Still further in the alternative, the rear view hunting mirror 1 can be mounted as illustrated in FIG. 4 on a limb 28, more particularly illustrating articulation of the respective coupling digits 8 in the flexible coupling 7 and adjustment of the mirror 2 into a second position for viewing the area behind the hunter.

As further illustrated in FIGS. 3, 4 and 5 of the drawings in a preferred embodiment of the invention the flexible coupling 7 is designed to articulate by means of multiple coupling digits 8 in a desired tension arrangement. Accordingly, fixed digit 8a of the flexible coupling 7 is mounted in fixed attachment to, or molded integrally with, the coupling bracket 5, in order to receive the remaining coupling digits 8, and the opposite end of the flexible coupling 7 includes the mount bracket digit 8b that may be likewise intergrally formed with or bolted against the convex surface 14a of the mount bracket 13, as heretofore described.

While the preferred embodiments of the invention have been described above, it will be recognized and understood that various modifications may be made in the invention and the amended claims are intended to cover all such modifications that may fall within the spirit and scope of the invention.

Having described my invention with the particularity set forth above, what is claimed is:

1. A rear view hunting mirror for mounting on a curved support, comprising a mirror; a flexible coupling having one end attached to said mirror; an arcuate mount bracket attached to the opposite end of said flexible coupling from said one end, for seating on the curved support; and a mount strap engaging said mount bracket for extending around the curved support and securing said mount bracket on the curved support.

2. The rear view hunting mirror of claim 1 wherein said flexible coupling comprises a plurality of coupling digits disposed between said mirror and said mount bracket in articulating relationship, to define said flexible coupling.

3. The rear view hunting mirror of claim 1 comprising a buckle mechanism attached to said mount strap and said mount bracket for tightening said mount strap and said mount bracket against the curved support.

4. The rear view hunting mirror of claim 3 wherein said flexible coupling comprises a plurality of coupling digits disposed between said mirror and said mount bracket in articulating relationship, to define said flexible coupling.

5. The rear view hunting mirror of claim 1 comprising a camouflage sleeve provided on said flexible coupling for camouflaging said flexible coupling.

6. The rear view hunting mirror of claim 5 wherein said flexible coupling comprises a plurality of coupling digits disposed between said mirror and said mount bracket in articulating relationship, to define said flexible coupling.

7. The rear view hunting mirror of claim 5 comprising a buckle mechanism attached to said mount strap and said mount bracket for tightening said mount strap and said mount bracket against the curved support.

8. The rear view hunting mirror of claim 5 wherein said flexible coupling comprises a plurality of coupling digits disposed between said mirror and said mount bracket in articulating relationship, to define said flexible coupling, and comprising a buckle mechanism attached to said mount strap and said mount bracket for tightening said mount strap and said mount bracket against the curved support.

9. A rear view hunting mirror for mounting on a tree comprising a mirror; a flexible coupling having one end attached to said mirror; an arcuate mount bracket removably attached to the opposite end of said flexible coupling from said one end, for seating on the tree, said mount bracket having a curvature less than the curvature of the tree; a buckle strap having one end engaging said mount bracket; a buckle mounted on said buckle strap; and a mount strap removably engaging said mount bracket, said mount strap adjustably engaging said buckle for removably securing said mount bracket on the tree responsive to tightening said mount strap in said buckle.

10. The rear view hunting mirror of claim 9 wherein said flexible coupling comprises a plurality of coupling digits disposed between said mirror and said mount bracket in articulating relationship, to define said flexible coupling.

11. The rear view hunting mirror of claim 9 comprising a camouflage sleeve provided on said flexible coupling for camouflaging said flexible coupling.

12. The rear view hunting mirror of claim 9 wherein said flexible coupling comprises a plurality of coupling digits disposed between said mirror and said mount bracket in articulating relationship, to define said flexible coupling and comprising a camouflage sleeve provided on said flexible coupling for camouflaging said flexible coupling.

13. A rear view hunting mirror for mounting on a tree, comprising a mirror; a flexible coupling having one end attached to said mirror; an arcuate mount bracket removably attached to the opposite end of said flexible coupling from said one end, said mount bracket having a curvature less than the curvature of the tree and edges provided on said mount bracket for seating on the tree; a buckle strap having one end engaging said mount bracket; a friction buckle mounted on said buckle strap; and a mount strap removably engaging said mount bracket, said mount strap adjustably engaging said friction buckle for removably securing said mount bracket on the tree responsive to tightening said mount strap in said friction buckle.

14. The rear view hunting mirror of claim 13 wherein said flexible coupling comprises a plurality of coupling digits disposed between said mirror and said mount bracket in articulating relationship, to define said flexible coupling.

15. The rear view hunting mirror of claim 13 comprising a camouflage sleeve provided on said flexible coupling for camouflaging said flexible coupling.

16. The rear view hunting mirror of claim 13 wherein said flexible coupling comprises a plurality of coupling digits disposed between said mirror and said mount bracket in articulating relationship, to define said flexible coupling and comprising a camouflage sleeve provided on said flexible coupling for camouflaging said flexible coupling.
